(19) United States
(12) Patent Application Publication
(10) Pub. No.: US 2013/0190049 A1
(43) Pub. Date: Jul. 25, 2013

(54) Interchangeable Faceplate User Interface System

(71) Applicant: DEVIUM LLC, Colorado Springs, CO (US)

(72) Inventor: Paul N. Lizer, Colorado Springs, CO (US)

(73) Assignee: DEVIUM LLC, Colorado Springs, CO (US)

(21) Appl. No.: 13/733,448

(22) Filed: Jan. 3, 2013

Related U.S. Application Data
(60) Provisional application No. 61/590,679, filed on Jan. 25, 2012.

(51) Int. Cl. H04M 1/02

(52) U.S. Cl. CPC H04M 1/0202
USPC 455/557

(57) ABSTRACT

A Interchangeable faceplate audio system for mobile devices has a body, a coupling system, a mobile device, and a removable faceplate. The body is adapted to be affixed to and communicate with the audio system. The body has a faceplate receiving surface. The faceplate receiving surface has a body terminal. The coupling system is within the body and communicates signals from the body terminal to the audio system. The removable faceplate is adapted to support the mobile device and to removably affix to the faceplate receiving surface. The removable faceplate has a mobile device connector for communicative connection with the mobile device and a body connector for communicative connection with the body terminal.

This application claims the benefit of U.S. Provisional Application No. 61/590,679 filed Jan. 25, 2012.

### BACKGROUND

Many mobile devices are underutilized with audio systems. For example, modern cellular telephones can store and play music. However, interfacing those telephones with an audio system is often cumbersome and inconvenient. Conventional audio systems include a dedicated user interface. Traditionally, utilizing a mobile device with an audio system does not replace the dedicated user interface with the mobile device.

### DESCRIPTION OF THE DRAWINGS

FIG. 1 is an illustration of one embodiment of the present invention interchangeable faceplate user interface system.

FIG. 2 is an illustration of one embodiment of the body of the present invention.

FIG. 3 is an illustration of an alternate embodiment of the body of the present invention showing magnetic connectors on the faceplate receiving surface.

FIG. 4 is an illustration of one embodiment of the removable faceplate of the present invention.

FIG. 5 is a side view illustration of one embodiment of the removable faceplate and the mobile device of the present invention.

FIG. 6 is an alternative illustration of one embodiment of the removable faceplate and the mobile device of the present invention.

FIG. 7 is an alternative illustration of one embodiment of the removable faceplate and the mobile device of the present invention.

FIG. 8 is a back view illustration of one embodiment of the removable faceplate of the present invention showing magnetic connectors on the faceplate.

### DETAILED DESCRIPTION

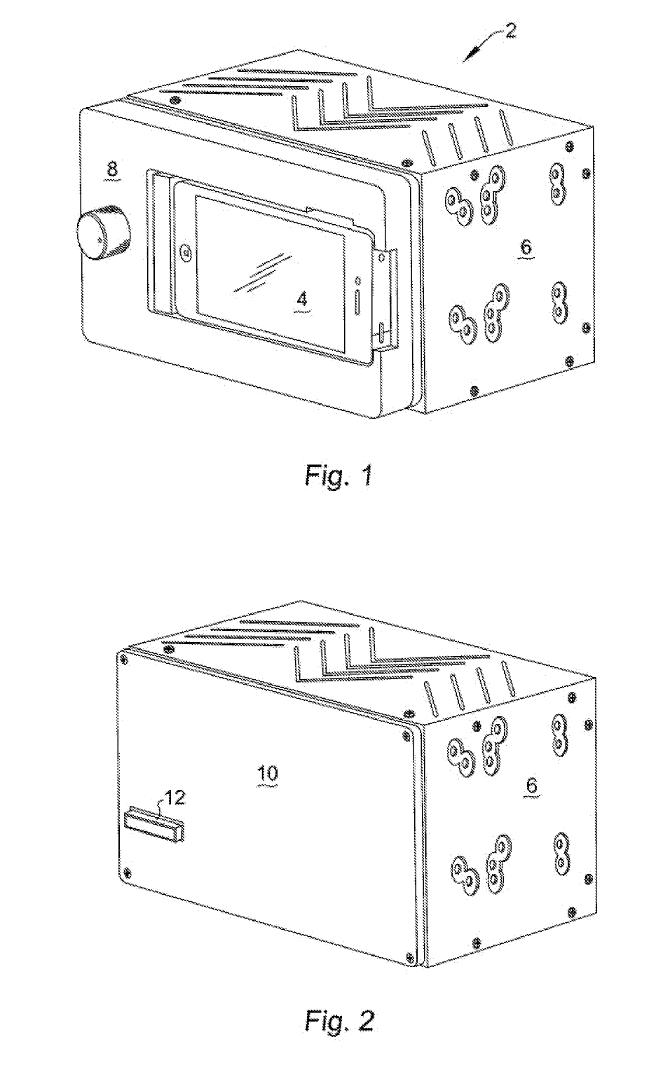

FIG. 1 shows one embodiment of the present invention interchangeable faceplate user interface system 2. The user interface system 2 has a mobile device 4 and a user interface system. The user interface system includes a body 6, a coupling system (not shown), and a removable faceplate 8. The audio system may be an automobile audio system, a portable audio system, or a home audio system.

FIG. 2 is an illustration of one embodiment of the body 6 of the present invention. The body 6 is adapted to be affixed to and be mounted within the audio system. In one embodiment, the body 6 is mounted in the audio system in place of the main component of the audio system. The body 6 is also in communication with the audio system through the coupling system disposed within the body 6. The body 6 has a faceplate receiving surface 10. The faceplate receiving surface 10 has a body terminal 12. The body terminal 12 communicates with the coupling system.

The coupling system communicates signals from the body terminal 12 to the audio system. In one embodiment, the coupling system includes conductors disposed with the body which interconnect the body terminal 12 and the audio system. In an alternate embodiment, the coupling system has additional circuitry for responding to signals from the mobile device 4.

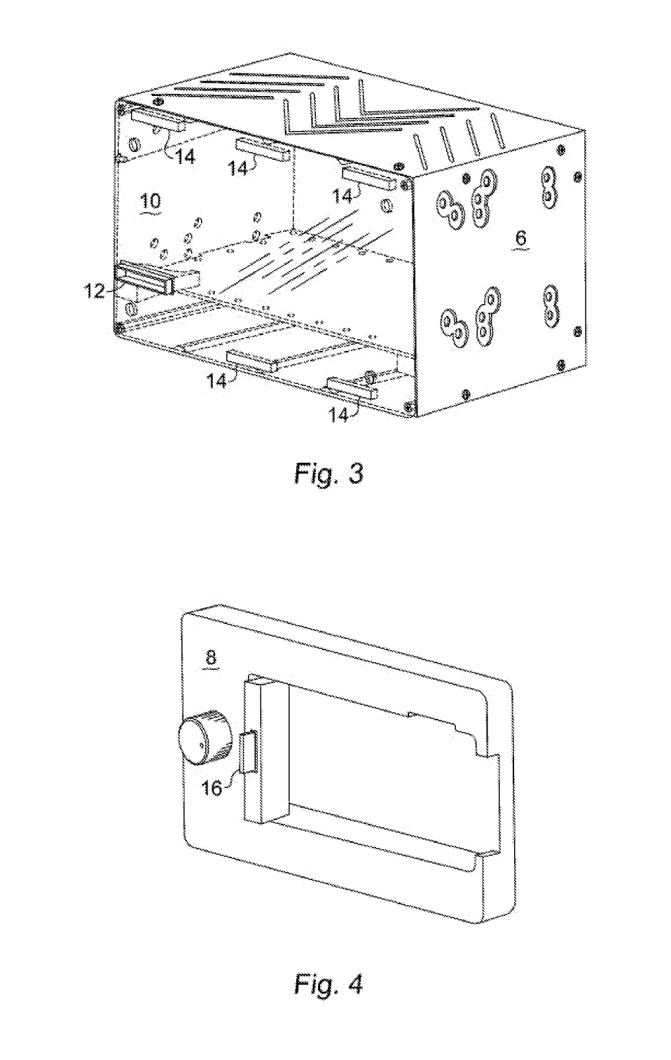

FIG. 3 is an illustration of an alternate embodiment of the body 6 of the present invention showing magnetic connectors 14 on the faceplate receiving surface 10. The magnetic connectors 14 allow the faceplate 8 to be easily removably affixed to the faceplate receiving surface 10.

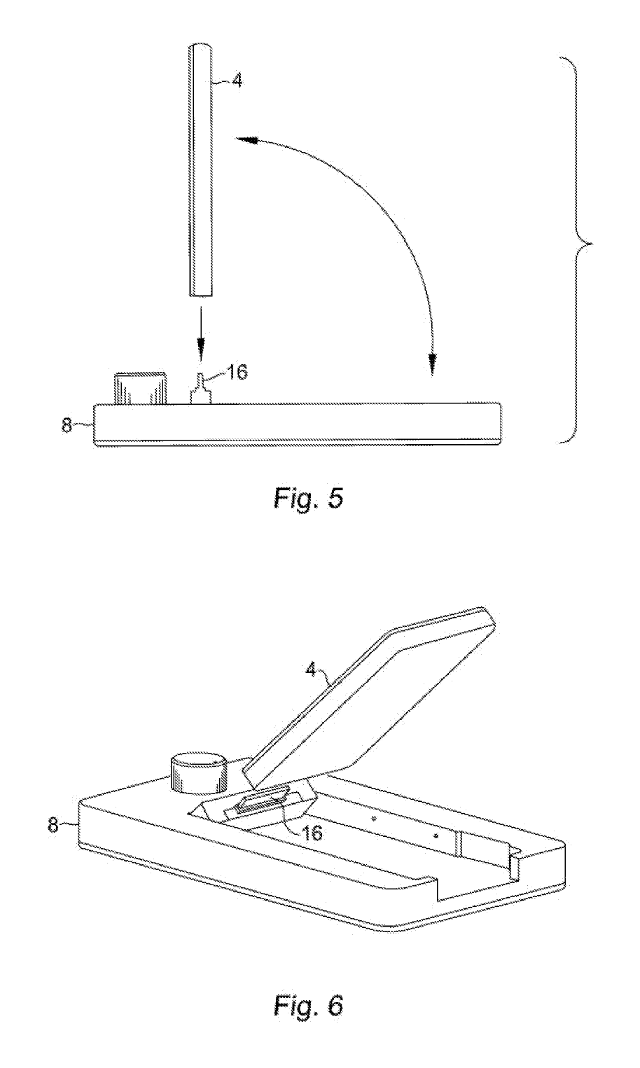

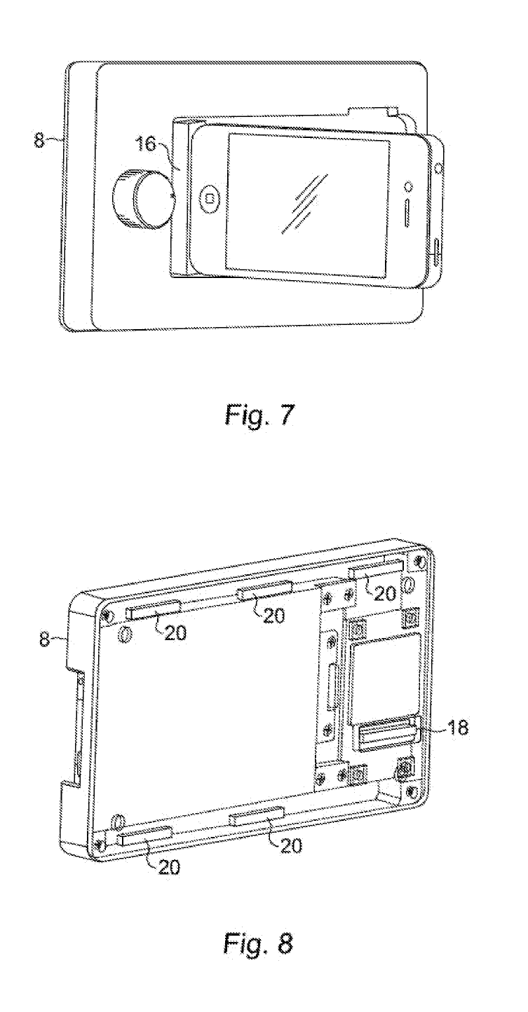

FIGS. 4-7 show one embodiment of the removable faceplate 8 of the present invention. The removable faceplate 8 is adapted to support the mobile device 4 and to removably affix to the faceplate receiving surface 10. The faceplate 8 may also receive the mobile device 4 so that the faceplate 8 securely supports the mobile device 4 and the mobile device 4 is disposed within the faceplate 8.

The removable faceplate 8 has a mobile device connector 16 and a body connector 18 (FIG. 8). The mobile device connector 16 interfaces with the mobile device to provide communication between the mobile device and the faceplate 8. The mobile device connector 16 communicatively connections with the mobile device 4. The body connector 18 interfaces with the body terminal 12 to provide communication between the body 6 and the faceplate 8. The body connector 18 communicatively connections with the body terminal 12.

The mobile device 4 may be any mobile device capable of acting as a user interface. In one embodiment, the mobile device 4 is a cellular telephone. In one embodiment, the faceplate 8 is uniquely designed to accommodate and receive each a specific shape and size of telephone.

FIG. 8 is a back view illustration of one embodiment of the removable faceplate 8 of the present invention showing magnetic connectors 20 on the back surface of the faceplate 8. The magnetic connectors 20 allow the faceplate 8 to be easily removably affixed to the faceplate receiving surface 10.

The interface system 2 may also include such components as an amplification system for amplifying audio signals generated from the mobile device 4 and a mobile device charging system for charging the mobile device 4 when the mobile device 4 is in communication with the mobile device connector 16.

The present invention solves the problem of using a mobile device 4 as the main component of car stereo, enabling the user to charge and use the functionality of the device 4 easily. The user no longer has to use the mobile device 4 through another graphical user interface (GUI). The user accesses the mobile device 4 organically through the device's operating system by docking the device 4 in the stereo. An added advantage of the present invention is that it reduces clutter and the mobile device 4 is brought to a stable location for easy access and becomes the brains and interface for the car stereo or other audio system.

In a specific embodiment, the present invention uses an interchangeable faceplate 8 that is custom designed for a specific mobile device 4 and marries it with a body 6 that is installed in the car.

The present invention is an improvement to what currently exists. Current car audio systems require a cable to charge and interface with a mobile device 4 through cables, wires, and wireless capabilities requiring the user to interface with the device 4 through another GUI, the dedicated GUI of the audio system.

Prior systems require more work for the user and then cause the user to neglect and not use the mobile device 4 or use it dangerously by holding the mobile device 4 while driving.

The faceplate 8 is where the mobile device 4 is secured and connects to the system and can be generalized for a group of mobile devices 4 or specific to a device 4. The body 6 is where the faceplate 8 is secured and connects to the system allowing the mobile device 4 to connect to the hardware that will supply audio amplification, battery charging, and connections to the car and the car's capabilities. The mobile device IO (Input/Output) connector 16 is where the mobile device 4 connects to the faceplate 8. The faceplate/body IO connector (body terminal 12 together with the body connector 18) allows the faceplate 8 to communicate with the body 6. The magnetic secure connectors 14, 20 are a system that requires no mechanical system to securely connect the faceplate 8 to the body 6.

The components of the audio system and the present invention work in conjunction to allow a mobile device 4 to be connected to the audio system physically thus giving the user the mobile devices capabilities immediately. The present invention is adaptable to different devices 4 by allowing the user to use and interchange different faceplates 8 depending on the device 4.

In one embodiment, creating the present invention requires a body 6 that fits into a car, a faceplate 8 that accepts mobile devices 4 to physically connect. A way for the faceplate 8 to connect to the body 6 and a system that allows different faceplates 6 to connect to the body 6. The body 6 contains general and specific circuitry to allow the mobile device 4 to send audio to the car speakers, to charge the mobile device, and to connect to the car and the car's capabilities.

The circuitry in the body 6 could be updated to supply additional capabilities and improve on the system but doesn't change the idea of the system.

In one embodiment, a user installs the present invention into their car. Depending on the mobile device 4 they are using they select the corresponding faceplate 8. The faceplate 8 is connected to the body 6 and then the mobile device 4 is connected and secured to the faceplate 8. Then the user is able to use the mobile device 4 to perform functions like playing music, make/receive phone calls, and access all capabilities of the mobile device 4 without holding the device 4 or requiring cables, wires, or wireless connections.

The foregoing description is only illustrative of the invention. Various alternatives and modifications can be devised by those skilled in the art without departing from the invention. Accordingly, the present invention embraces all such alternatives, modifications, and variances that fall within the scope of the appended claims.

What is claimed is:

1. A user interface system for allowing a mobile device to be used as the main user interface component in an audio system, the user interface system comprising:
a body adapted to be affixed to and communicate with the audio system, the body having a faceplate receiving surface, the faceplate receiving surface having a body terminal;
a coupling system within the body for communicating signals from the body terminal to the audio system; and
a removable faceplate adapted to support the mobile device and to removably affix to the faceplate receiving surface, the removable faceplate having a mobile device connector for communicative connection with the mobile device and a body connector for communicative connection with the body terminal.

2. The user interface system of claim 1 wherein the body is further adapted to mount into the audio system.

3. The user interface system of claim 1 wherein the faceplate is further adapted to receive the mobile device.

4. The user interface system of claim 1 further including magnetic connectors for removably affixing the removable faceplate to the faceplate receiving surface.

5. The user interface system of claim 1 wherein the coupling system includes conductors disposed with the body and interconnecting the body terminal and the audio system.

6. The user interface system of claim 1 wherein the mobile device is a cellular telephone.

7. A user interface system for an audio system, the user interface system comprising:
a body adapted to be affixed to and communicate with the audio system, the body having a faceplate receiving surface, the faceplate receiving surface having a body terminal;
a coupling system within the body for communicating signals from the body terminal to the audio system;
a mobile device; and
a removable faceplate adapted to support the mobile device and to removably affix to the faceplate receiving surface, the removable faceplate having a mobile device connector for communicative connection with the mobile device and a body connector for communicative connection with the body terminal.

8. The user interface system of claim 7 wherein the body is further adapted to mount into the audio system.

9. The user interface system of claim 7 wherein the faceplate is further adapted to receive the mobile device.

10. The user interface system of claim 7 further including magnetic connectors for removably affixing the removable faceplate to the faceplate receiving surface.

11. The user interface system of claim 7 wherein the coupling system includes conductors disposed with the body and interconnecting the body terminal and the audio system.

12. The user interface system of claim 7 wherein the mobile device is disposed within the faceplate.

13. The user interface system of claim 7 wherein the mobile device is a cellular telephone.

14. The user interface system of claim 7 further including an amplification system in communication with the coupling system.

15. The user interface system of claim 7 further including a mobile device charging system disposed to provide power to the mobile device connector.
